(19) United States
(12) Patent Application Publication
(10) Pub. No.: US 2019/0295093 A1
(43) Pub. Date: Sep. 26, 2019

(54) Multiple Card Message-Based Payment System, Apparatuses and Method Thereof

(71) Applicant: MASTERCARD INTERNATIONAL INCORPORATED, Purchase, NY (US)

(72) Inventors: Andrew Buckley, Kenilworth (GB); Mohit Bijlani, Fort Lee, NJ (US); Adam J Telem, New York, NY (US)

(73) Assignee: MASTERCARD INTERNATIONAL INCORPORATED, Purchase, NY (US)

(21) Appl. No.: 16/363,707

(22) Filed: Mar. 25, 2019

Related U.S. Application Data
(60) Provisional application No. 62/647,408, filed on Mar. 23, 2018.
(60) Provisional application No. 62/647,376, filed on Mar. 23, 2018.

(51) Int. Cl. G06Q 20/40; G06Q 20/34; G06N 5/02; G06N 20/00

(52) U.S. Cl. CPC G06Q 20/4037; G06N 20/00; G06N 5/02; G06Q 20/354

(57) ABSTRACT

A payment card system including: an artificial intelligence (AI) platform configured to: identify a first payment card account of a cardholder; receive, via a message or messenger-based channel, an inquiry related to a purchase the cardholder desires to make using the first payment card account; interactively communicate with the cardholder via the message or messenger-based channel using artificial intelligence; determine a cost of the purchase relative to the balance of the first payment card account; if the cost of the purchase exceeds the balance of the first payment card account, identify a second payment card account of the cardholder; and initiate creation of a third payment card account that combines at least a portion of the balance of the first payment card account and at least a portion of a balance of the second payment account. The payment card system also includes one or more entities of a bank-related network.

### CROSS REFERENCE TO RELATED APPLICATIONS

This application claims benefit of priority to U.S. Provisional Patent Application No. 62/647,408 and U.S. Provisional Patent Application No. 62/647,376, both filed Mar. 23, 2018, the contents and disclosure of which are hereby incorporated by reference herein in their entirety.

### BACKGROUND

Conventionally, a single payment card is used to make a purchase. Sometimes a split payment using two different cards is allowed, but this is commonly not available for e-commerce transactions due to the sometimes difficult checkout experience of electronically completing a split-payment purchase. As a result, particularly for e-commerce transactions, payment cards, including, for example, prepaid cards (e.g., gift cards), are often declined or rejected because of an insufficient balance, or a purchase dollar-amount limit exists on the payment card account associated with the payment card. In fact, the vast majority of declines for prepaid cards are attributed to insufficient balances (oftentimes very small amounts) for the applicable transaction, which significantly taxes payment card systems and programs, due to the subsequent follow-up and inquiry actions (both virtually and manually) that must be taken by a user (or merchant) after a transaction is declined. Numerous statistics show the tremendous strain on payment card systems simply because transactions are declined and rejected.

### SUMMARY

Consistent with the disclosure, exemplary embodiments of systems, apparatuses, and methods for enabling message-based communication for performing message-based transactions with respect to multiple payment card accounts, are disclosed.

According to an embodiment, there is provided a payment card system. The payment card system may include: an artificial intelligence (AI) platform configured to: identify a first payment card account of a user; receive, via a message or messenger-based channel, an inquiry related to a potential purchase using the identified first payment card account; interactively communicate with the user via the message or messenger-based channel using artificial intelligence; determine a balance of the first payment card account and calculate a cost of the purchase relative to the balance of the first payment card account; if the cost of the purchase exceeds the balance of the first payment card account, identify a second payment card account of the user; and initiate creation of a third payment card account that combines at least a portion of the balance of the first payment card account and at least a portion of a balance of the second payment account based on communications with an bank-related network. The payment card system may further include one or more entities of the bank-related network, the one or more devices comprising: a memory; a receiver configured to receive a command to create a third payment card account from the AI platform; and a processor coupled to the memory, the processor configured to authenticate the user in the bank-related network.

The operation of identifying the first payment card account of the user may include communicating with the one or more entities of the bank-related network and receiving information related to the first payment card account from at least one of the one or more devices.

The creation of the third payment card account may include communicating with one or more devices in the bank-related network.

The AI platform may automatically communicate with a merchant to complete the purchase.

The operation of identifying the second payment card account of the user may include at least one of communicating with the user via the message or messenger-based channel and automatically communicating with one or more devices in the bank-related network.

According to another exemplary embodiment, there is provided a payment card account service method. The method may include: identifying a first payment card account of a user; receiving, via a message or messenger-based channel, an inquiry related to a potential purchase using the identified first payment card account; interactively communicating with the user via the message or messenger-based channel using artificial intelligence; determining a balance of the first payment card account and calculating a cost of the purchase relative to the balance of the first payment card account; if the cost of the purchase exceeds the balance of the first payment card account, identifying a second payment card account of the user; automatically initiating creation of a third payment card account that combines at least a portion of the balance of the first payment card account and at least a portion of a balance of the second payment account based on communications with a bank-related network; and transmitting information related to the third payment card account to the user via the message or messenger-based channel.

The operation of identifying the first payment card account of the user may include communicating with one or more entities in a bank-related network and receiving information related to the first payment card account from at least one of the one or more entities.

The creation of the third payment card may include communicating with one or more entities in a bank-related network.

The method may further include automatically communicating with a merchant to complete a purchase.

The operation of identifying the second payment card account of the user may include at least one of communicating with the cardholder via the message or messenger-based channel and automatically communicating with one or more entities in a bank-related network.

According to another exemplary embodiment, there is provided a payment card account service method. The method may include: identifying a first payment card account of a user based on information received from the user; automatically communicating with the user via the message or messenger-based channel using artificial intelligence; receiving a command from the user to create one of a new payment card or a virtual payment card number; identifying a second payment card account of the user; automatically initiating creation of the one of the new payment card or virtual payment card number, wherein the one of the new payment card or virtual payment card number has a balance that is a combination of at least a portion of a balance of the first payment card account and at least part of a balance of a second payment account; and transmitting information related to the one of the new payment card or virtual payment card number to the user via the message or messenger-based channel.

The operation of identifying the first payment card account of the user may include communicating with one or more entities in a bank-related network and receiving information related to the first payment card account from at least one of the one or more entities.

The creation of the new payment card or virtual payment card number may include communicating with one or more entities in a bank-related network.

The operation of identifying the second payment card account of the user may include at least one of communicating with the user via the message or messenger-based channel and automatically communicating with one or more entities in a bank-related network.

According to yet another exemplary embodiment, there is provided at least one non-transitory computer readable storage medium comprising a set of instructions which, when executed by a computing device, cause the computing device to: identify a first payment card account of a user; receive, via a message or messenger-based channel, an inquiry related to a purchase the user desires to make using the identified first payment card account; interactively communicate with the user via the message or messenger-based channel using artificial intelligence; determine a balance of the first payment card account and calculate a cost of the purchase relative to the balance of the first payment card account; if the cost of the purchase exceeds the balance of the first payment card account, identify a second payment card account of the user; automatically initiate creation of a third payment card account that combines at least a portion of the balance of the first payment card account and at least a portion of a balance of the second payment account based on communications with an bank-related network; and transmit information related to the third payment card account to the user via the message or messenger-based channel.

The operation of identifying the first payment card account of the user may include communicating with one or more entities in a bank-related network and receiving information related to the first payment card account from the one or more entities.

The creation of the third payment card may include communicating with one or more entities in a bank-related network.

The operation of identifying the second payment card account of the user may include at least one of communicating with the user via the message or messenger-based channel and automatically communicating with one or more entities in a bank-related network

It is to be understood that both the foregoing general description and the following detailed description are exemplary and explanatory only and are not restrictive of this disclosure.

### BRIEF DESCRIPTION OF THE DRAWINGS

The various embodiments will become apparent to one skilled in the art by reading the following specification and appended claims, and by referencing the following drawings, in which:

FIGS. 1A-1C are flow diagrams illustrating several different processes, respectively, according to exemplary embodiments;

FIG. 2 illustrates a system enabling payments using multiple cards using a message-based communication network and bank-related network, according to an exemplary embodiment.

FIG. 3 illustrates a method of completing a purchase using multiple payment cards according to an exemplary embodiment;

FIG. 4 illustrates a block diagram of a computing device according to an exemplary embodiment;

FIG. 5 is a block diagram of a semiconductor package apparatus according to an exemplary embodiment; and

FIG. 6 is a block diagram of another computing system according to an exemplary embodiment.

### GLOSSARY OF TERMS

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, Visa®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc. Use of the terms “credit card” or “credit card company” herein may refer to both the physical card or the card-producing company and/or non-physical accounts or the payment network companies that create the non-physical accounts.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

Point of Sale—A computing device or computing system configured to receive interaction with a user (e.g., a consumer, employee, etc.) for entering in transaction data, payment data, and/or other suitable types of data for the purchase of and/or payment for goods and/or services. The point of sale may be a physical device (e.g., a cash register, kiosk, desktop computer, smart phone, tablet computer, etc.) in a physical location that a customer visits as part of the transaction, such as in a “brick and mortar” store, or may be virtual in e-commerce environments, such as online retailers receiving communications from customers over a network such as the Internet. In instances where the point of sale may be virtual, the computing device operated by the user to initiate the transaction or the computing system that receives data as a result of the transaction may be considered the point of sale, as applicable.

### DESCRIPTION

Oftentimes, payment cardholders, particularly prepaid cardholders, will have multiple different payment cards that, when aggregating the balances, would have a sufficient balance to cover the cost of a transaction that would be declined based on a single payment card (since a single payment card used for the declined transaction may not have a sufficient balance). Consumers that make e-commerce transactions, in particular, do not have access to technology to easily and quickly leverage, access, and aggregate available funds in each of their individual payment card accounts (e.g., issuer and payment-brand agnostic cards) to create an account that will have a sufficient balance to cover the cost of, e.g., an e-commerce transaction. In view of the long-standing challenges in the conventional art that have yet to be addressed in a satisfactory way, exemplary embodiments disclosed herein seek to address some of the deficiencies of conventional technology. Notwithstanding the novelty and uniqueness of exemplary embodiments, each exemplary embodiment may or may not necessarily address certain deficiencies of conventional technology.

While the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” an illustrative embodiment,” etc., indicate that the embodiment described may include a particular feature, structure, or characteristic, but every embodiment may or may not necessarily include that particular feature, structure, or characteristic. Further, when a particular feature, structure, or characteristic is described in connection with an embodiment, it is submitted that it is within the knowledge of one skilled in the art to affect such feature, structure, or characteristic in connection with other embodiments whether or not explicitly described.

The disclosed embodiments may be implemented, in some cases, in hardware, firmware, software, or any combination thereof. The disclosed embodiments may also be implemented as instructions carried by or stored on a machine readable (e.g., computer-readable) medium or machine-readable storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

Exemplary embodiments provide innovative and novel solutions by providing systems, methods, and apparatuses for making a purchase by aggregating balances of multiple payment cards. For example, account information (e.g., an account number or virtual card number) of a newly generated account that aggregates the balances of payment cards already held by the cardholder may be provided to the consumer via a consumer-friendly AI/chatbot experience. Such a solution may be implemented using a short message service (SMS) or SMS-based app when a consumer only has a feature phone, or the solution may be provided via an app when a consumer has a smartphone. Secure or non-secure message/messenger-based communication channels/platforms/networks (e.g., short message service (SMS), WHATSAPP, FACEBOOK Messenger, etc.) may also be implemented. Hereinbelow, the terms “channel,” “platform,” and “network” may be used interchangeably, and these terms and related concepts are known and understood by skilled artisans. According to an exemplary embodiment, the disclosed solutions may be accomplished by combining a unique artificial intelligence (AI) platform/bot with message or messenger-based communication channels/platforms/networks (discussed below).

According to another exemplary embodiment, a unique AI platform may be combined with a message or messenger-based communication channels/platforms/networks (discussed below). The AI platform may cross-communicate with, for example, bank networks, to enable the functional feature of making a purchase using multiple payment cards. The message or messenger-based communication channel/platform/network may be implemented through wired and/or wireless communication means and associated protocols (e.g., Ethernet, Bluetooth®, Wi-Fi®, WiMAX, LTE, etc.) to affect such communication.

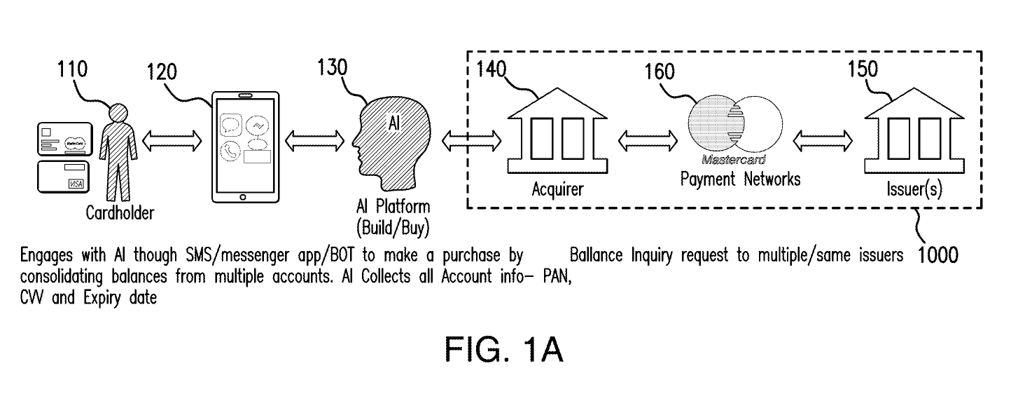

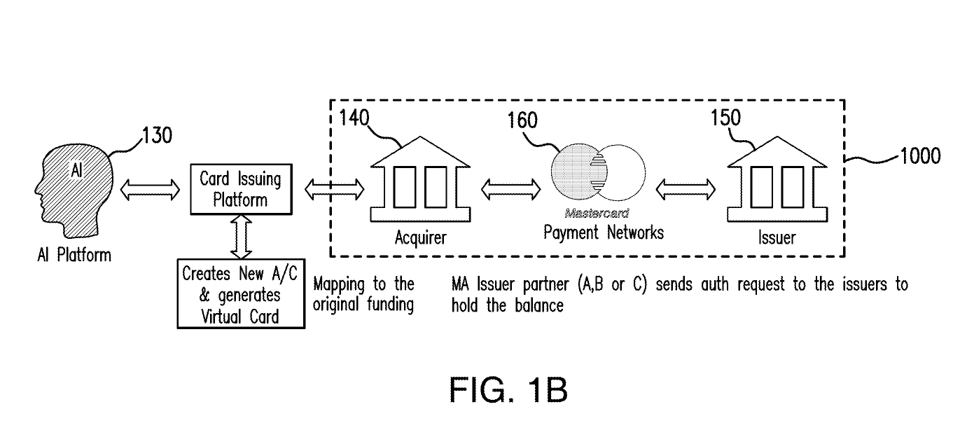

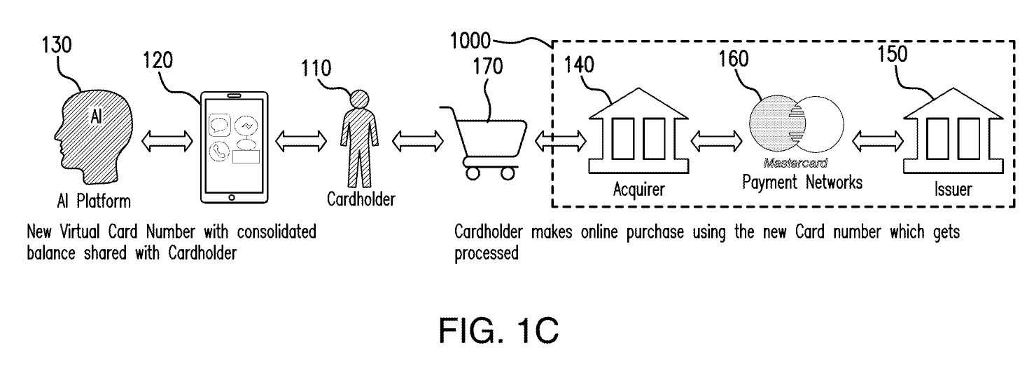

Referring now to FIGS. 1A-1C, there are provided flow diagrams illustrating different operations related to exemplary processes for completing a purchase using balances of multiple payment cards. According to the illustrated exemplary embodiment, a user/cardholder 110 may communicate with an AI platform/BOT 130, using, for example, a mobile device 120. In FIG. 1A, the user/cardholder 110 may interact via, e.g., a message or messenger-based communication channel/platform/network, with AI platform/BOT 130 regarding a purchase. The AI platform/BOT 130 may send an inquiry to, e.g., a bank-related network (e.g., interbank network or ATM network) 1000 to obtain information on the balances of different cards of the user/cardholder 110. The inquiry may be transmitted between an acquirer 140, a credit card company 160, and/or issuer(s) 150. The acquirer 140, the credit card company 160, and/or the issuer 150 may all be entities in the bank-related network.

According to an exemplary embodiment, the AI platform/BOT 130 may not need to consult entities of a bank-related network to obtain information about the balances of payment cards of a cardholder 110. The AI platform/BOT 130 may store information related to payment accounts of particular cardholders. The AI platform/BOT 130 may be automatically and periodically updated with such information, or may be updated based on a manual request or specific request for updating.

According to an exemplary embodiment, the transmission of the balance information among the various entities in the bank-related network 1000 may be performed on one or more ATM networks (e.g., Cirrus, Mastercard's network, LINK, etc) and/or an existing bank-related network implementing International Organization for Standardization (ISO) standards for bank networks (e.g., worldwide ATM network). Differently, the communication between the user/cardholder 110 and the AI platform/BOT 130 may be performed via a message or messenger-based communication channel/platform/network or message or messenger-based app. The message or messenger-based communication channel/platform/network may support or use different protocols than are used in the bank-related network 1000.

The platforms/networks/channels according to exemplary embodiments may be implemented using one or more different communication protocols, including, but not limited to, Short Message Service (SMS), Wideband Code Division Multiple Access (W-CDMA), Universal Mobile Telecommunications System (UMTS), CDMA2000 (IS-856/IS-2000), etc.), Wireless Fidelity (WiFi, e.g., IEEE 802.11-2007, Wireless Local Area Network (LAN) Medium Access Control (MAC) and Physical Layer (PHY) Specifications, etc.), Light Fidelity (LiFi, e.g., IEEE 802.15-7, Wireless LAN MAC and PHY, etc.), Long Term Evolution (LTE, e.g., 4G, 5G, etc.), Bluetooth (e.g., IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), etc.

Referring now to FIG. 1B, based on the information that is communicated from the bank-related network 1000 to the AI platform/BOT 130 and/or information provided by a user/cardholder 110, the AI platform/BOT 130 may initiate a process of creating a new account and/or virtual card number in order to complete a purchase. The AI platform/BOT 130 may perform the operation of creating and generating the new account and/or virtual card number itself, or it may issue a command for a card issuing company in the bank-related network 1000 to perform these operations. The new account and/or virtual card may be used to complete a purchase based on an aggregation of the balances of different cards/accounts of the user/cardholder 110. To ensure the integrity of the exemplary processes and the account/card balances, issuer(s) of the relevant cards/accounts may put the accounts/balances on hold and may not allow them to be used until the transaction is complete. A card issuer entity may create the request to put the account/balance on hold, or a business partner of the card issuer entity may create the request.

The balances (or at least a portion thereof) of the cardholder accounts that are potentially subject to being combined may now be aggregated to create a balance of a new account and/or virtual card account. In other words, a consolidated balance may be available via the new account and/or new virtual card/virtual card number.

Referring now to FIG. 1C, according to an exemplary embodiment the AI platform/BOT 130 may communicate a new virtual card number with a user/cardholder 110 via a message or messenger-based channel/network/platform. The user/cardholder 110 may then use the new virtual card number to make the desired purchase via, for example, an online merchant 170.

The channel/platform/network via which the user device 120 and the AI platform/BOT 130 communicate may be implemented via a message or messenger-based communication channel/platform/network and/or via an app that uses a message or messenger-based communication channel/platform/network for communication. The communication channel/platform/network for interacting with the AI BOT 130 may be a message or messenger-based channel/platform/network whereby the AI BOT 130 cross-communicates with the cardholder/user 110.

FIGS. 1A-1C illustrate exemplary process flows, but it should be noted that in other exemplary embodiments, one or more of the illustrated bank-related network nodes (e.g., acquirer, credit card company, or issuer) may or may not be necessary to complete the purchase using multiple cards.

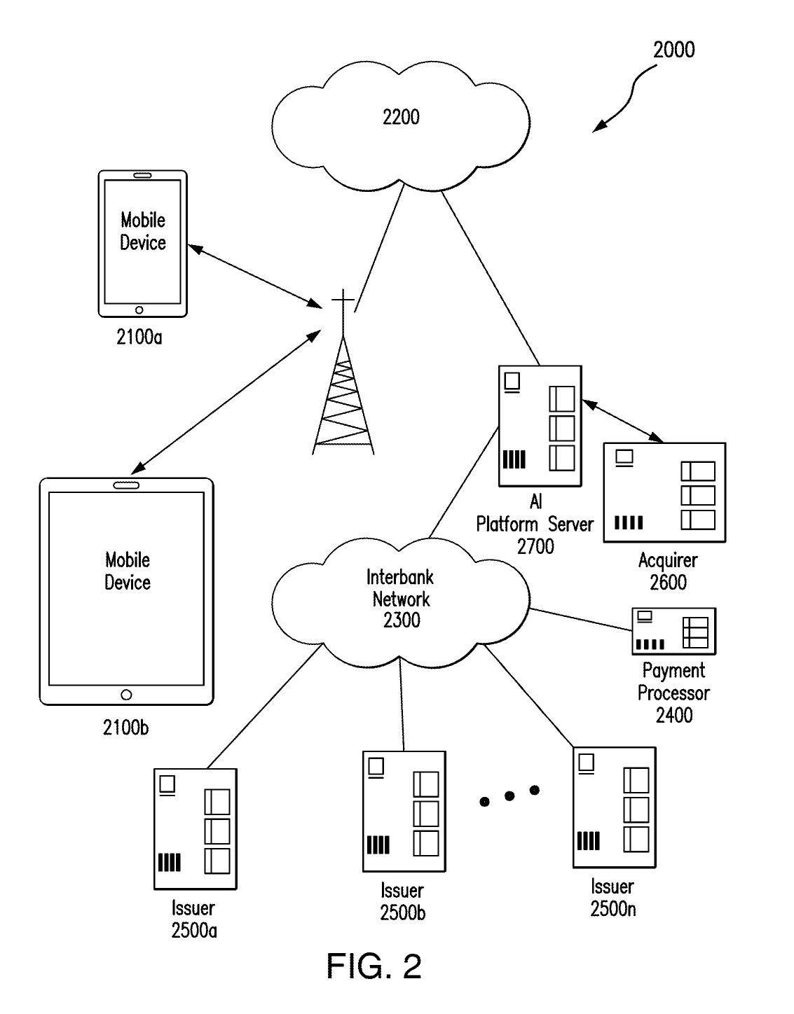

FIG. 2 illustrates an embodiment of a system 2000 configured to enable payments using multiple cards using a message-based communication network and a bank-related network, where the system is constructed and operative in accordance with exemplary embodiments of the present disclosure. System 2000 includes consumers using one or more mobile devices 2100a/2100b to connect to an AI platform server 2700 via a message or messenger-based communication channel/platform/network 2200.

Mobile computing devices 2100a/2100b may include mobile devices such as mobile telephones, tablet computers, laptop computers, “ultra-books” or other portable computing device known in the art capable of communicating with AI platform server 2700 via the message or messenger-based communication channel/platform/network 2200.

As shown in FIG. 2, AI platform server 2700 may be connected to payment processor 2400, acquirer 2600, and issuers 2500 via an interbank/bank-related network 2300. Payment processor 2400 may be a payment network capable of processing payments electronically. Example payment processors 2400 may include Mastercard International Incorporated. Issuers 2500 may include any banks and other entities that issue payment cards. An interbank network 2300 may be a computer network that connects different banking institutions. For example, an Automated Teller Machine (ATM) consortium network may be an interbank network.

If necessary, an acquirer 2600 may process payment card transactions on behalf of a merchant. The acquirer may be a bank or other financial institution authorized to process payment card transactions on a merchant's behalf. The acquirer may exchange funds with an issuer in instances where a consumer, which may be a beneficiary to a line of credit offered by the issuer, transacts, via a payment card, with a merchant that is represented by the acquirer.

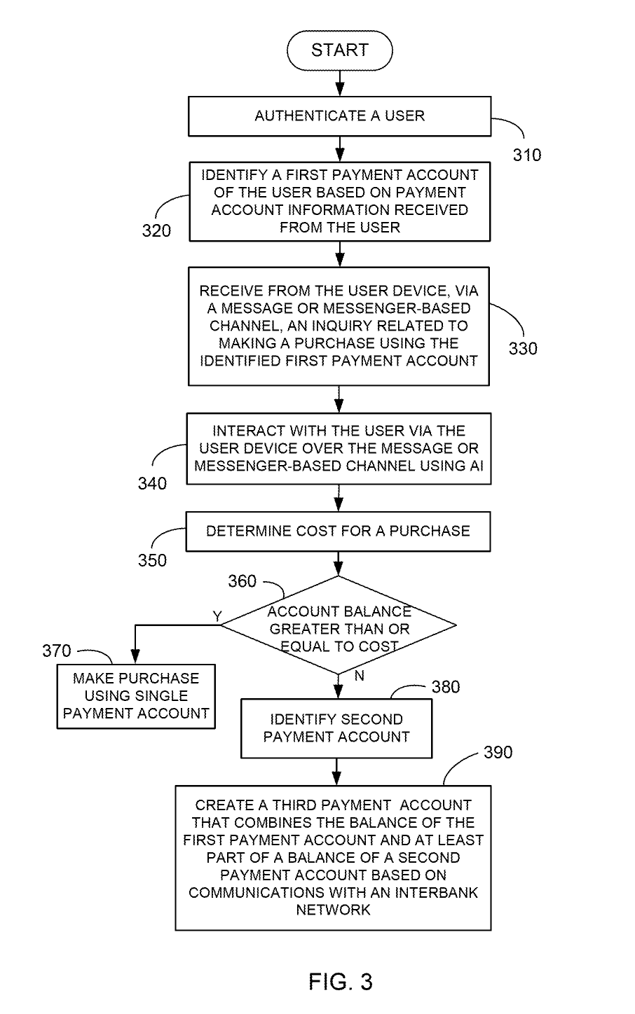

FIG. 3 illustrates a method of an artificial intelligence device/platform/BOT, in which the AI device/platform/BOT communicates with a user via a message or messenger-based channel to complete a purchase based on the balances of multiple cards, according to an exemplary embodiment.

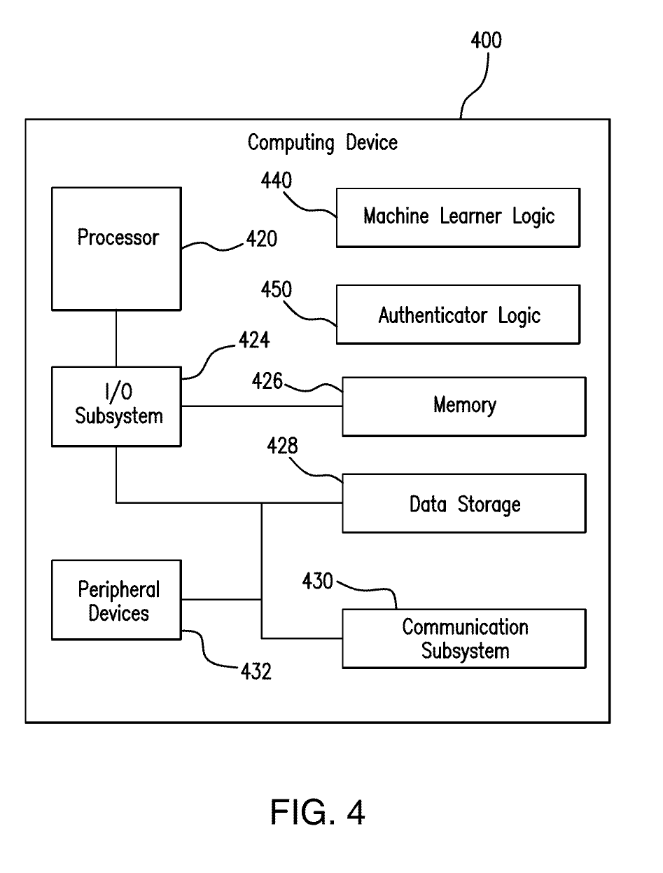

In block 310, an AI device/platform/BOT 130 may authenticate a user after receiving user information transmitted from a mobile device 120 of a user/cardholder 110. The AI platform/BOT 130 may be implemented in a computing device, such as the computing device illustrated in FIG. 4 (described below). In block 320, the AI platform 130 may identify a first payment card account of a user/cardholder 110 based on received user information. The AI platform 130 may identify the first payment card account of the user/cardholder 110 independently or may communicate with other nodes within, for example, an interbank network to determine a first payment card account of a user/cardholder 110.

In block 330, the AI platform 130 may receive from the user/cardholder 110, via a message or messenger-based channel/platform/network, an inquiry related to making a purchase using the identified first payment card account. In block 340, the AI platform/BOT 130 may interact with the user via the user's device 120 over the message or messenger-based channel/platform/network using AI.

In block 350, the AI platform/BOT 130 may determine a balance of the first payment card account. In block 360, an AI device/platform/BOT may determine whether a balance of the first payment card account is greater than or equal to the cost of the purchase. If the cost to make the purchase exceeds the balance of the first payment card account, the AI platform/BOT 130, in block 380, may automatically identify a second payment card account. The AI platform/BOT may take into consideration a number of factors to ensure that a transaction is successfully completed. For example, it may consider whether foreign currency is being used to complete the transaction, in which a buffer amount may need to be established to account for foreign transaction fees. The AI platform/BOT 130 may also identify a second payment card account based on additional AI-driven interactions and communications with the user/cardholder 110 via the user device 120. If, in block 360, it is determined that the account balance of the first payment card account is greater than or equal to the cost of the purchase, the purchase may be completed, in block 370, using the single payment card account.

In block 390, a third payment card account may be automatically created. The third payment card account may combine at least a part of the balance of the first payment card account and at least part of the balance of a second payment card account based on communications within a bank-related network. The third payment card account may be created by the AI platform/BOT 130 or initiated by the AI platform/BOT 130 such that the account is created by an entity within the bank-related network.

According to an exemplary embodiment, an exemplary interaction between a user/cardholder 110 and an AI platform/BOT 130 to complete a purchase using multiple account balances, may be as follows:

Consumer (CN): I need to make a purchase with my card
Chatbot (CB): Are you sure?

### CN: Yes

CB: Tell me the card or gift card number

### CN: 5400 000 000 000

### CB: Expiry?

### CN: 10/18

### CB: And CVC?

### CN: 123

CB: And is there a name on the card?

### CN: No

CB: OK then how much do you need to pay?

### CN: $54.99

CB: I see the balance on your card is $50
CB: Therefore, the balance to pay is $4.99 which I can obtain from another card.
CB: Tell me the card or gift card number of a different card.

### CN: 6400 000 000 000

CB: expiry?

### CN: 9/18

### CB: And CVC?

### CN: 456

CB: Is there a name on the card?

### CN: No

CB: OK. I will create a new card, charge both of your cards $50.00 and $5.00, respectively, and the new card will have a value of $55.00.
CB: The number of the new card with the balance of $55.00 is 7400 000 000 000.

The method illustrated in FIG. 3 may be implemented in a computing device or system. The computing device or system may be a user level device or system or a server-level device or system. More particularly, the methods may be implemented in one or more modules as a set of logic instructions stored in a machine or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method of FIG. 3 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, and/or other structural components that are native to hardware (e.g., host processor, central processing unit/CPU, microcontroller, etc.).

Referring now to FIG. 4, an exemplary computing device 400 (e.g., an AI platform/BOT 130) for performing the method of FIG. 3 is shown. The computing device 400 may include a processor 420, a memory 426, a data storage 428, a communication subsystem 430 (e.g., transmitter, receiver, transceiver, etc.), and an I/O subsystem 424. Additionally, in some embodiments, one or more of the illustrative components may be incorporated in, or otherwise form a portion of, another component. For example, the memory 426, or portions thereof, may be incorporated in the processor 420 in some embodiments. The computing device 400 may be embodied as, without limitation, a mobile computing device, a smartphone, a wearable computing device, an Internet-of-Things device, a laptop computer, a tablet computer, a notebook computer, a computer, a workstation, a server, a multiprocessor system, and/or a consumer electronic device. Additionally, the computing device 400 may be one of several computing devices used to perform the method of FIG. 3, where computational resources may be shared between the several different computing devices.

The processor 420 may be embodied as any type of processor capable of performing the functions described herein. For example, the processor 420 may be embodied as a single or multi-core processor(s), digital signal processor, microcontroller, or other processor or processing/controlling circuit.

The memory 426 may be embodied as any type of volatile or non-volatile memory or data storage capable of performing the functions described herein. In operation, the memory 426 may store various data and software used during operation of the computing device 400 such as operating systems, applications, programs, libraries, and drivers. The memory 426 is communicatively coupled to the processor 420 via the I/O subsystem 424, which may be embodied as circuitry and/or components to facilitate input/output operations with the processor 420, the memory 426, and other components of the computing device 400.

The data storage device 428 may be embodied as any type of device or devices configured for short-term or long-term storage of data such as, for example, memory devices and circuits, memory cards, hard disk drives, solid-state drives, non-volatile flash memory, or other data storage devices.

The computing device 400 may also include a communications subsystem 420, which may be embodied as any communication circuit, device, or collection thereof, capable of enabling communications between the computing device 400 and other remote devices over a computer network (not shown). The communications subsystem 430 may be configured to use any one or more communication technology (e.g., wired or wireless communications) and associated protocols (e.g., Ethernet, Bluetooth®, Wi-Fi®, WiMAX, LTE, etc.) to affect such communication. The communications subsystem 430 may be configured to simultaneously or sequentially communicate over a message or messenger-based communication channel/network/platform and any type of separate channel, including, but not limited to, a bank-related/interbank network.

As shown, the computing device 400 may further include one or more peripheral devices 432. The peripheral devices 432 may include any number of additional input/output devices, interface devices, and/or other peripheral devices. For example, in some embodiments, the peripheral devices 432 may include a display, touch screen, graphics circuitry, keyboard, mouse, speaker system, microphone, network interface, and/or other input/output devices, interface devices, and/or peripheral devices. The computing device 400 may also perform one or more of the functions described in detail herein and/or may store any of the data or information referred to herein as it relates to the AI platform/BOT 430.

The computing device 400 may further include machine learner logic 440 and authenticator logic 450. The machine learner logic 440 learns communication patterns associated with respective cardholders and may tailor the choices of words used for communication to specific cardholders. In one example, the machine learner logic 440 of the computing device (i.e., the AI bot) may learn how a particular user prefers to communicate (e.g., formal dialog, colloquial or relaxed dialog, etc.). The AI bot may be able to perform natural language processing to decipher communications from a user. Such learning may be performed passively and/or continually. The authenticator logic 450 may authenticate a cardholder so that a cardholder may access his or her account information.

While examples have provided various components of the computing device 400 for illustration purposes, it should be understood that one or more components of the computing device 400 may reside in the same and/or different physical and/or virtual locations, may be combined, omitted, bypassed, re-arranged, and/or be utilized in any order. For example, the machine learner logic 440 and/or the authenticator logic 450 may reside in the same and/or different physical and/or virtual location as a component of the computing device 400 (e.g., both may reside in the processor). Moreover, any or all components of the computing device 400 may be automatically implemented (e.g., without human intervention, etc.). The computing device 400 may also perform one or more of the functions described in detail herein and/or may store any of the data or information referred to herein as it relates to the AI platform/BOT 130.

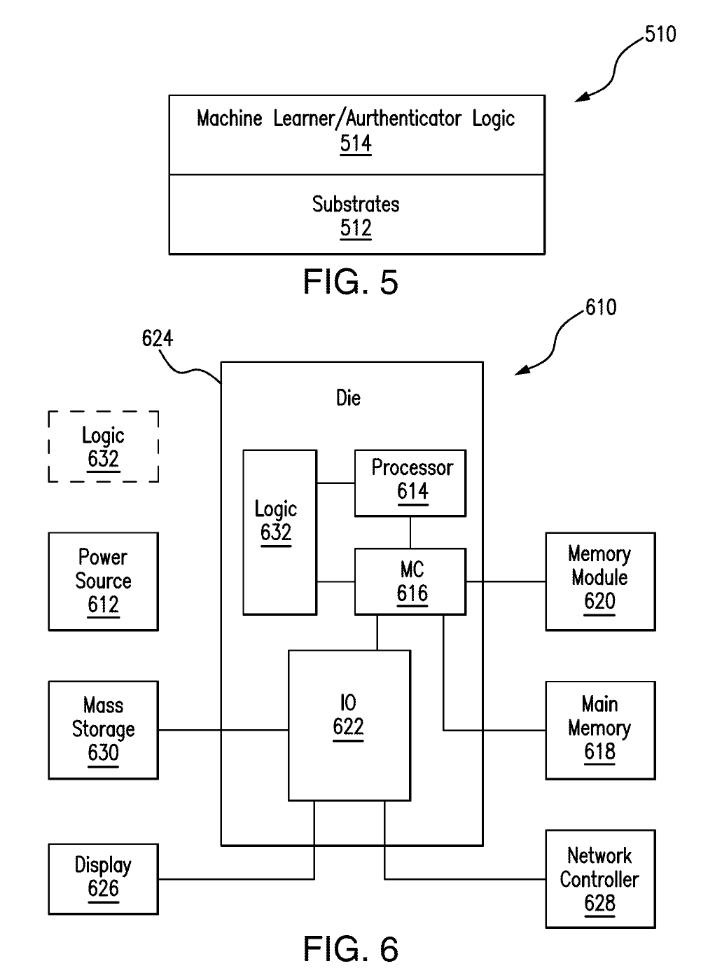

Turning now to FIG. 5, an embodiment of a semiconductor package apparatus 510 includes one or more substrates 512 (e.g., silicon, sapphire, gallium arsenide, etc.) and machine learner/authenticator logic 514 (e.g., transistor array and other integrated circuit/IC components, etc.) coupled to the substrates 512. The apparatus 510 may be implemented in one or more components of the system 100 (FIG. 1) and/or computing device 400 (FIG. 4), already discussed. Moreover, the apparatus 510 may implement one or more of the aspects of the method of FIG. 3, already discussed.

Embodiments of the machine learner/authenticator logic 514, and other components of the apparatus 510, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. In one example, the machine learner/authenticator logic 514 may include transistor channel regions positioned (e.g., embedded) within the substrates 512. Thus, the interface between the machine learner/authenticator logic 514 and the substrates 512 may not be an abrupt junction. The machine learner/authenticator logic 514 may also be considered to include an epitaxial layer that is grown on an initial wafer of the substrates 512.

Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

Turning now to FIG. 6, an example of an electronic processing system 610 is shown to provide machine learning and authentication according to an embodiment. The system 610 may generally be part of an electronic device/platform having computing functionality (e.g., datacenter, cloud server, personal digital assistant/PDA, notebook computer, tablet computer, laptop, etc.), imaging functionality (e.g., camera, projector, etc.), media playing functionality (e.g., smart television/TV, gaming platform, smart phone, etc.), wearable functionality (e.g., watch, eyewear, headwear, footwear, etc.), vehicular functionality (e.g., car, truck, motorcycle, etc.), communication functionality, and so on.

The system 610 includes a power source 612. The system 610 also includes a processor 614, such as a micro-processor, an embedded processor, a digital signal processor (DSP), a central processing unit (CPU), a graphical processing unit (GPU), a visual processing unit (VPU), a network processor, hardware that executes code to implement one or more aspects of the technology described herein, etc. For example, the processor 614 may include one or more cores to execute operations (e.g., a single-threaded core, a multithreaded core including more than one hardware thread context (or “logical processor”) per core, etc.). The processor 614 may also be coupled to internal storage such as a cache (e.g., instruction cache, data cache, single level cache, multilevel cache, shared cache, strictly inclusive cache, exclusive cache, etc.), etc.

In the illustrated example, the processor 614 is communicatively coupled to a memory controller 616 that controls access to a memory device. The illustrated memory controller 616 is communicatively coupled to main memory 618. The main memory 618 may include, for example, RAM, ROM, PROM, EPROM, EEPROM, etc., PCM, 3D memory, etc. The memory controller 616 is also communicatively coupled to memory module 620. The memory module 620 may include, for example, DRAM configured as one or more memory modules such as dual inline memory modules (DIMMs), small outline DIMMs (SODIMMs), etc. Thus, the memory controller 616 may control direct memory access (DMA), remote DMA (RDMA), and so on.

The system 610 also includes an input output (IO) module 622 implemented together with the processor 614 and the memory controller 616 on a semiconductor die 624 as an SoC, wherein the 10 module 622 functions as a host device and may communicate with, for example, a display 626 (e.g., touch screen, liquid crystal display/LCD, light emitting diode/LED display), a network controller 628 (e.g., Ethernet controller, etc.), and mass storage 630 (e.g., hard disk drive/HDD, optical disk, flash memory, etc.). The system 610 further includes logic 632 communicatively coupled to the processor 614, the memory controller 616, and the 10 module 622 on the semiconductor die 624. The logic 632 may also be implemented elsewhere in the system 610 and/or outside of the system 610. The logic 632 may be the same the machine learner/authenticator logic 514 (FIG. 5), already discussed. Moreover, the logic 632 may implement one or more of the aspects of the method of FIG. 3, discussed above. Thus, the logic 632 provides passive biometric authentication and/or vehicle function control based on passive biometric authentication.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The flow diagrams and block diagrams in the Figures illustrate the architecture, functionality, and operation of possible implementations of systems, methods and computer program products according to various exemplary embodiments. In this regard, each block in the flow diagrams or block diagrams may represent a module, segment, or portion of code, which comprises one or more executable instructions for implementing the specified logical function(s). It should also be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow diagram illustrations, and combinations of blocks in the block diagrams and/or flowchart illustrations, may be implemented by special purpose hardware-based systems that perform the specified functions or acts, or combinations of special purpose hardware and computer instructions.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so on” or “etc.” may mean any combination of the listed terms as well with other terms.

The application titled “Message Based Payment Card System, Apparatuses, and Method Thereof”, filed on Mar. 25, 2019 and having the same inventors as the instant application, is hereby incorporated by reference herein in its entirety. This incorporation by reference is limited such that no subject matter is incorporated that is contrary to the explicit disclosure herein.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A payment card system comprising:
an artificial intelligence (AI) platform configured to:
identify a first payment card account of a user;
receive, via a message or messenger-based channel, an inquiry related to a potential purchase using the identified first payment card account;
interactively communicate with the user via the message or messenger-based channel using AI;
determine a balance of the first payment card account;
calculate a cost of the potential purchase relative to the balance of the first payment card account;
if the cost of the potential purchase exceeds the balance of the first payment card account, identify a second payment card account of the user; and
initiate creation of a third payment card account that combines at least a portion of the balance of the first payment card account and at least a portion of a balance of the second payment account based on communications with a bank-related network; and
one or more entities of the bank-related network, the one or more entities comprising:
a memory;
a receiver configured to receive a command to create a third payment card account from the AI platform; and
a processor coupled to the memory, the processor configured to authenticate the user in the bank-related network.

2. The system of claim 1, wherein the identifying the first payment card account of the user includes communicating with the one or more entities of the bank-related network and receiving information related to the first payment card account from at least one of the one or more entities in the bank-related network.

3. The system of claim 1, wherein the creation of the third payment card account includes communicating with at least one of the one or more entities in the bank-related network.

4. The system of claim 1, wherein the AI platform automatically communicates with a merchant to complete the potential purchase.

5. The system of claim 1, wherein the identifying the second payment card account of the user includes at least one of communicating with the user via the message or messenger-based channel and automatically communicating with at least one of the one or more entities in the bank-related network.

6. A payment card account service method, the method comprising:
identifying a first payment card account of a user;
receiving, via a message or messenger-based channel, an inquiry related to a potential purchase using the identified first payment card account;
interactively communicating with the user via the message or messenger-based channel using artificial intelligence (AI);
automatically determining a balance of the first payment card account;
calculating a cost of the potential purchase relative to the balance of the first payment card account;
if the cost of the potential purchase exceeds the balance of the first payment card account, identifying a second payment card account of the cardholder;
automatically initiating creation of a third payment card account that combines at least a portion of the balance of the first payment card account and at least a portion of a balance of the second payment account based on communications with a bank-related network; and
transmitting information related to the third payment card account to the user via the message or messenger-based channel.

7. The method of claim 6, wherein the identifying the first payment card account of the user includes communicating with one or more entities in a bank-related network and receiving information related to the first payment card account from at least one of the one or more entities.

8. The method of claim 6, wherein the creating the third payment card includes communicating with one or more entities in a bank-related network.

9. The method of claim 6, further comprising automatically communicating with a merchant to complete the potential purchase.

10. The method of claim 6, wherein the identifying the second payment card account of the user includes at least one of communicating with the user via the message or messenger-based channel and automatically communicating with one or more entities in a bank-related network.

11. A payment card account service method, the method comprising:
identifying a first payment card account of a user;
automatically communicating with the user via the message or messenger-based channel using artificial intelligence (AI);
receiving a command from the user to create one of a new payment card or a virtual payment card number;
identifying a second payment card account of the user;
automatically initiating creation of the one of the new payment card or virtual payment card number, wherein a balance of the one of the new payment card or virtual payment card number is a combination of at least a portion of a balance of the first payment card account and at least part of a balance of a second payment account; and
transmitting information related to the one of the new payment card or virtual payment card number to the user via the message or messenger-based channel.

12. The method of claim 11, wherein the identifying the first payment card account of the user includes communicating with one or more entities in a bank-related network and receiving information related to the first payment card account from at least one of the one or more entities.

13. The method of claim 11, wherein the creating the one of the new payment card or virtual payment card number includes communicating with one or more entities in a bank-related network.

14. The method of claim 11, further comprising automatically communicating with a merchant to complete a purchase.

15. The method of claim 11, wherein the identifying the second payment card account of the cardholder includes at least one of communicating with the user via the message or messenger-based channel and automatically communicating with one or more entities in a bank-related network.

16. At least one non-transitory computer readable storage medium comprising a set of instructions which, when executed by a computing device, cause the computing device to:
identify a first payment card account of a user;
receive, via a message or messenger-based channel, an inquiry related to a potential purchase using the identified first payment card account;
interactively communicate with the user via the message or messenger-based channel using artificial intelligence (AI);
automatically determine a balance of the first payment card account and calculate a cost of the potential purchase relative to the balance of the first payment card account;
if the cost of the potential purchase exceeds the balance of the first payment card account, identify a second payment card account of the cardholder;
automatically initiate creation of a third payment card account that combines at least a portion of the balance of the first payment card account and at least a portion of a balance of the second payment account based on communications with a bank-related network; and
transmit information related to the third payment card account to the user via the message or messenger-based channel.

17. The at least one non-transitory computer readable storage medium of claim 16, wherein the identifying the first payment card account of the user includes communicating with one or more entities in a bank-related network and receiving information related to the first payment card account from at least one of the one or more entities.

18. The at least one non-transitory computer readable storage medium of claim 16, wherein the creating the third payment card includes communicating with one or more entities in a bank-related network.

19. The at least one non-transitory computer readable storage medium of claim 16, which, when the set of instructions are executed by the computing device, further cause the computing device to automatically communicate with a merchant to complete the potential purchase.

20. The at least one non-transitory computer readable storage medium of claim 16, wherein the identifying the second payment card account of the user includes at least one of communicating with the user via the message or messenger-based channel and automatically communicating with one or more entities in a bank-related network.
